(19) United States
(12) Patent Application Publication
(10) Pub. No.: US 2024/0112571 A1
(43) Pub. Date: Apr. 4, 2024

(54) CONGESTION PREDICTION DEVICE, CONGESTION PREDICTION METHOD, AND STORAGE MEDIUM

(71) Applicant: TOYOTA JIDOSHA KABUSHIKI KAISHA, Toyota-shi (JP)

(72) Inventors: Ayumu SHIOMI, Toyota-shi (JP); Atsushi MIYAGAWA, Toyota-shi (JP); Hiroki TAKEUCHI, Toyota-shi (JP); Toshiyuki KAWAI, Kariya-shi (JP); Ryosuke FUKAYA, Toyota-shi (JP); Hiroyuki TOKITA, Toyota-shi (JP); Yusuke IKENOUE, Takahama-shi (JP); Tsukasa KATO, Toki-shi (JP); Katsuhisa YOSHIKAWA, Miyoshi-shi (JP); Yuta ICHIJYO, Toyota-shi (JP); Takayuki AKAISHI, Toyota-shi (JP); Shintaro KAWAI, Toyota-shi (JP)

(73) Assignee: TOYOTA JIDOSHA KABUSHIKI KAISHA, Toyota-shi (JP)

(21) Appl. No.: 18/474,320

(22) Filed: Sep. 26, 2023

(30) Foreign Application Priority Data
Oct. 3, 2022 (JP) 2022-159604

(51) Int. Cl. G08G 1/01; G06N 3/044; G08G 1/052

(52) U.S. Cl. CPC G08G 1/0133; G06N 3/044; G08G 1/0129; G08G 1/052

(57) ABSTRACT

A congestion prediction device, a congestion prediction method, and a storage medium are provided. A mapping outputs an output variable when input variables are input to the mapping. The output variable indicates a degree of congestion in a predetermined specific area. The mapping is learned in advance by machine learning. The input variables include congestion variables. Each of the congestion variables indicates a degree of congestion in the specific area at regular time intervals within a specific period. The output variable indicates a degree of congestion after a lapse of the regular time interval from an end time of the specific period.

### BACKGROUND

### 1. Field

The present disclosure relates to a congestion prediction device, a congestion prediction method, and a storage medium.

### 2. Description of Related Art

A congestion prediction device of Japanese Laid-Open Patent Publication No. 2021-189734 predicts congestion of vehicles for an expressway. Specifically, the congestion prediction device of the literature divides the expressway into multiple sections along a traveling direction of the expressway in advance. The sections include a first section and a second section. The second section is adjacent to the first section and is located upstream of the first section in the traveling direction. Further, the congestion prediction device of the literature acquires a traffic volume, a vehicle density, and the like of the first section when predicting congestion of the second section. Then, the congestion prediction device of the above-cited patent literature predicts a traffic volume of the second section based on the traffic volume, the vehicle density, and the like of the first section.

### SUMMARY

In one general aspect, a congestion prediction device includes an execution circuit and a memory. The memory stores mapping data that defines a mapping. The execution circuit is configured to acquire input variables and output an output variable by inputting the acquired input variables to the mapping. The mapping outputs the output variable when the input variables are input to the mapping. The output variable indicates a degree of congestion in a predetermined specific area. The mapping is learned in advance by machine learning. The input variables include congestion variables. Each of the congestion variables indicates a degree of congestion in the specific area at regular time intervals within a specific period. The output variable is a variable indicating a degree of the congestion after a lapse of the regular time interval from an end time of the specific period.

According to the configuration described immediately above, with respect to the same specific area, the degree of congestion after the lapse of the regular time interval from the end time of the specific period is predicted on the basis of the degree of congestion at the regular time intervals within the specific period. In this way, when predicting the degree of congestion in the future, the accuracy of prediction is improved by referring to the degree of congestion in the past within a specific period.

Meanwhile, the causes of congestion occurring in a certain specific area include not only congestion in an area adjacent to the specific area, but also past congestion in the same specific area. However, since the congestion prediction device of the previously described patent literature does not consider the relationship described in the configuration, there is room for improvement. The configuration described immediately above provides such an improvement.

Other aspects of the present disclosure provide a congestion prediction method and a non-transitory computer readable medium that have features similar to those of the congestion prediction device having a configuration described above.

Other features and aspects will be apparent from the following detailed description, the drawings, and the claims.

### BRIEF DESCRIPTION OF THE DRAWINGS

FIG. 1 is a schematic diagram of a congestion prediction system according to the present disclosure.

FIG. 2 is a sequence diagram illustrating processes executed by the congestion prediction system of FIG. 1.

FIG. 3 is a schematic diagram of an LSTM neural network in the mapping shown in FIG. 1.

FIG. 4 is an explanatory diagram regarding date information as one of input variables input to the mapping of FIG. 3.

FIG. 5 is an explanatory diagram illustrating a transition of an average vehicle speed predicted by the congestion prediction system illustrated in FIG. 1.

FIG. 6 is an explanatory diagram related to contents shown by a display of a personal terminal provided by the congestion prediction system shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Schematic Configuration of Congestion Prediction System

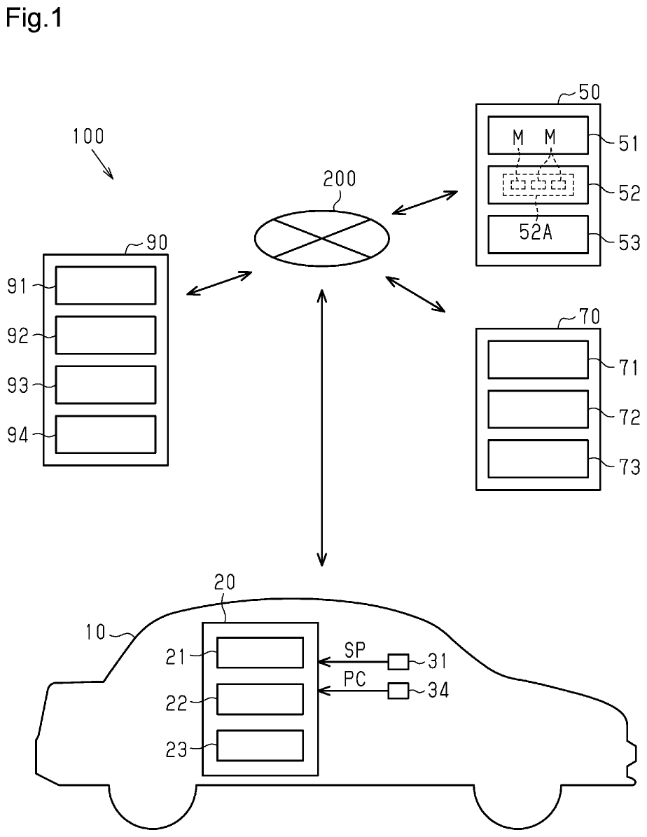

Hereinafter, an embodiment of the present disclosure will be described with reference to FIGS. 1 to 6. First, a schematic configuration of a congestion prediction system 100 including a congestion prediction device will be described.

As illustrated in FIG. 1, the congestion prediction system 100 includes multiple vehicles 10. The vehicles 10 are, for example, automobiles owned by users. In FIG. 1, only one vehicle 10 is illustrated as a representative.

The vehicle 10 includes a vehicle speed sensor 31 and a global navigation satellite system (GNSS) receiver 34. The vehicle speed sensor 31 detects a vehicle speed SP, which is the speed of the vehicle 10. The GNSS receiver 34 detects position coordinates PC, which are coordinates of a point where the vehicle 10 is located, by communication with GNSS artificial satellites (not illustrated). The GNSS is a global positioning satellite system.

The vehicle 10 includes a vehicle control device 20. The vehicle control device 20 acquires signals indicating various values from the vehicle speed sensor 31 and the GNSS receiver 34.

The vehicle control device 20 includes a vehicle execution circuit 21, a vehicle storage circuit 22, and a vehicle communication unit 23. The vehicle communication unit 23 can wirelessly communicate with devices outside the vehicle 10 via a communication network 200. The vehicle storage circuit 22 stores information and the like acquired by the vehicle control device 20. The vehicle storage circuit 22 is a vehicle memory that stores various programs in advance. The vehicle execution circuit 21 is a vehicle execution unit that executes various processes by reading programs stored in the vehicle storage circuit 22. An example of the vehicle execution circuit 21 is a central processing unit (CPU).

As illustrated in FIG. 1, the congestion prediction system 100 includes a data center 50. The data center 50 includes a center execution circuit 51, a center storage circuit 52, and a center communication unit 53. The center communication unit 53 can communicate with devices outside the data center 50 via the communication network 200. The center storage circuit 52 is a center memory that stores information and the like acquired by the data center 50. That is, the center storage circuit 52 can function as a memory of the congestion prediction system 100. The center storage circuit 52 also stores in advance mapping data 52A that defines mappings M. The mappings M are learned in advance by machine learning. Each mapping M outputs an output variable indicating the degree of congestion in a predetermined specific area by inputting input variables. The number of the mappings M is the same as the number of specific areas. In FIG. 1, only three mappings M are illustrated as representatives. A specific description of the mappings M will be given later. The center storage circuit 52 stores various programs in advance. The center execution circuit 51 is a center execution unit that executes various processes by reading programs stored in the center storage circuit 52. An example of the center execution circuit 51 is a CPU. An example of the data center 50 is a server. In the present embodiment, the data center 50 functions as a congestion prediction device. The center execution circuit 51 executes a congestion prediction program stored in the center storage circuit 52, so that the data center 50 executes processes of the congestion prediction method and the congestion prediction process. The center storage circuit 52 may be a non-transitory computer readable medium storing programs for causing the center execution circuit 51 to execute the congestion prediction process.

As illustrated in FIG. 1, the congestion prediction system 100 includes a weather information center 70. The weather information center 70 includes a weather execution circuit 71, a weather storage circuit 72, and a weather communication unit 73. The weather communication unit 73 can communicate with devices outside the weather information center 70 via the communication network 200. The weather storage circuit 72 is a weather memory that stores information and the like acquired by the weather information center 70. The weather storage circuit 72 also stores various programs in advance. An example of the weather execution circuit 71 is a CPU. An example of the weather information center 70 is a server.

The weather execution circuit 71 is a weather execution unit that executes various processes by reading programs stored in the weather storage circuit 72. Specifically, the weather execution circuit 71 acquires information regarding the weather by communication with observation sensors (not illustrated) at a predetermined control cycle. Then, the weather execution circuit 71 acquires current weather information IW and current precipitation amount information IP for predetermined specified points on the basis of information regarding the weather acquired from the observation sensors or the like. The weather information IW is, for example, a numerical value indicating weather such as sunny, cloudy, rainy, or snowy. In addition, the precipitation amount information IP is a numerical value indicating the precipitation amount per unit time. The weather storage circuit 72 stores the current weather information IW and precipitation amount information IP acquired by the weather execution circuit 71 for each specified point. By repeatedly storing the weather information IW and the precipitation amount information IP, the weather storage circuit 72 stores the weather information IW and the precipitation amount information IP from the present to the time before the specified period. In addition, the weather execution circuit 71 acquires information regarding the weather by communication with an artificial satellite for weather forecast (not illustrated) at a predetermined control cycle. Then, the weather execution circuit 71 predicts future weather information IW and future precipitation amount information IP for predetermined specified points on the basis of information related to weather acquired from a weather forecast artificial satellite or the like. The weather storage circuit 72 stores future weather information IW and precipitation amount information IP predicted by the weather execution circuit 71 for each specified point.

As illustrated in FIG. 1, the congestion prediction system 100 includes personal terminals 90. Each personal terminal 90 is, for example, a smartphone owned by a user. In FIG. 1, only one personal terminal 90 is illustrated as a representative.

The personal terminal 90 includes a terminal execution circuit 91, a terminal storage circuit 92, a terminal communication unit 93, and a display 94. The terminal communication unit 93 can communicate with devices outside the personal terminal 90 via the communication network 200. The terminal storage circuit 92 is a terminal memory that stores information and the like acquired by the personal terminal 90. In addition, the terminal storage circuit 92 stores various programs in advance. The terminal execution circuit 91 is a terminal execution unit that executes various processes by reading programs stored in the terminal storage circuit 92. An example of the terminal execution circuit 91 is a CPU. The display 94 can display various types of information. The display 94 is a touch panel display. Therefore, the user can also input various types of information via the display 94.

Acquisition Control

Next, acquisition control executed by the data center 50, the vehicle control devices 20 of the vehicles 10, and the weather information center 70 will be described.

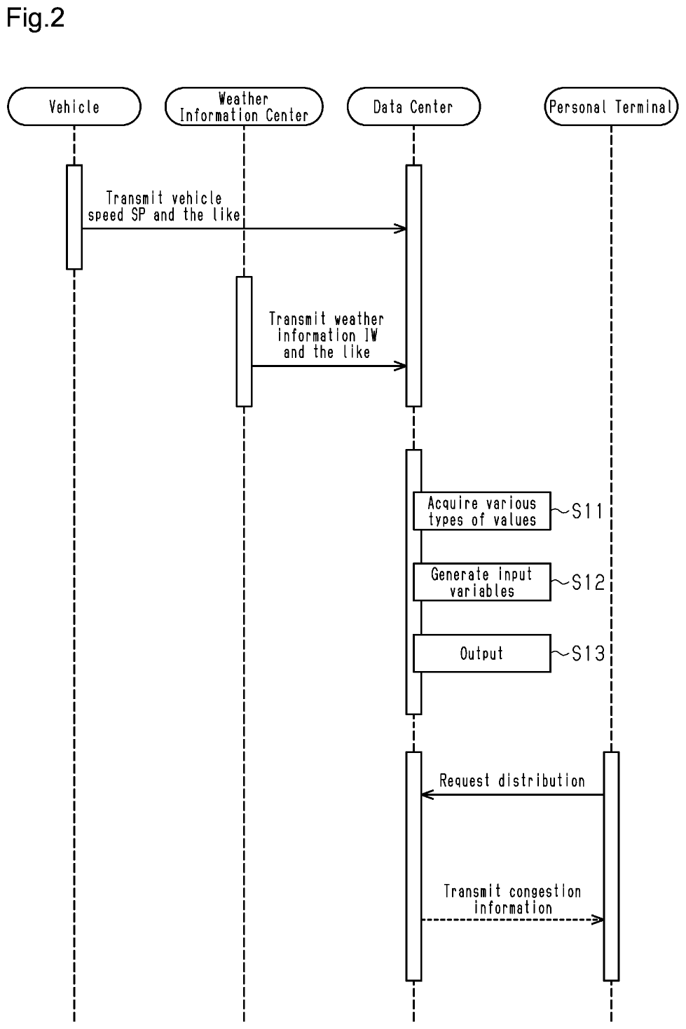

As illustrated in FIG. 2, in the acquisition control, the vehicle control device 20 of the vehicle 10 transmits a signal indicating the vehicle speed SP and the position coordinates PC to the data center 50 at a predetermined control cycle. At this time, the vehicle control device 20 transmits the vehicle speed SP and the position coordinates PC as a set of data. Although FIG. 2 illustrates that the vehicle speed SP and the like are transmitted from one vehicle 10 to the data center 50, actually, multiple vehicles 10 each transmit the vehicle speed SP and the like to the data center 50. The data center 50 receives a signal indicating the vehicle speed SP and the position coordinates PC. In addition, the center execution circuit 51 of the data center 50 determines to which specific area among predetermined specific areas the received position coordinates PC belongs. When the position coordinates PC belonging to the specific area are present, the center execution circuit 51 of the data center 50 determines the vehicle speed SP paired with the position coordinates PC as the vehicle speed SP of the specific area. Then, the center execution circuit 51 of the data center 50 associates the vehicle speed SP with the date and time when the signal indicating the vehicle speed SP is received, and stores the vehicle speed SP as information of the specific area. An example of the specific area is an area obtained by dividing a road in the same traveling direction into several tens of meters to several hundreds of meters along the traveling direction.

On the other hand, in the acquisition control, the weather information center 70 transmits a signal indicating the weather information IW and the precipitation amount information IP for each specified point to the data center 50 at a predetermined control cycle. The data center 50 receives a signal indicating the weather information IW and the precipitation amount information IP. The center execution circuit 51 of the data center 50 selects, for each specific area, a specified point closest to the specific area. Then, the center storage circuit 52 of the data center 50 stores the weather information IW and the precipitation amount information IP for the selected specified point in association with the target specific area.

Prediction Control

Next, prediction control executed by the data center 50 will be described. The center execution circuit 51 of the data center 50 executes prediction control multiple times for each specific area every time a predetermined timing is reached. The center execution circuit 51 can predict one average vehicle speed SPA as a variable indicating the degree of congestion by performing the prediction control once for a specific area for prediction. The center execution circuit 51 can predict the average vehicle speed SPA during a predetermined period by repeatedly executing the prediction control. An example of the predetermined timing is a specific point in time of a specific day such as 15:00 on Wednesday. An example of the predetermined period is two weeks. First, the first prediction control performed by the data center 50 on the specific area for prediction will be described.

As illustrated in FIG. 2, when starting the prediction control, the center execution circuit 51 of the data center 50 executes the process of step S11. In step S11, the center execution circuit 51 acquires an average vehicle speed SPA of a specific area for prediction at regular time intervals within a specific period. In the present embodiment, the length of the specific period is three hours. The length of the regular time interval is 15 minutes.

Specifically, when the center execution circuit 51 executes the prediction control at 15:00, the center execution circuit 51 sets the point in time for prediction to 15:15, which is the next regular time interval after 15:00. In this case, the center execution circuit 51 accesses the center storage circuit 52 to acquire multiple vehicle speeds SP from 12:00 to 15:00 for the specific area for prediction. Then, the center execution circuit 51 calculates an average vehicle speed SPA, which is an average value of the vehicle speeds SP, at predetermined regular time intervals. For example, the center execution circuit 51 uses the average value of the multiple vehicle speeds SP from 12:00 to 12:15 for the specific area as the average vehicle speed SPA at 12:15. Similarly, the center execution circuit 51 calculates an average vehicle speed SPA up to 15:00 at 15-minute intervals. Therefore, the center execution circuit 51 acquires a total of twelve average vehicle speeds SPA. The center storage circuit 52 also stores a total of twelve average vehicle speeds SPA calculated by the center execution circuit 51.

In the present embodiment, the start time of the specific period is 12:00, which is 3 hours and 15 minutes before 15:15, which is the target prediction point in time. Further, the end time of the specific period is 15:00, which is 15 minutes before 15:15, which is the target prediction point in time. Therefore, the target prediction point in time is a point in time after a lapse of the regular time interval from the end time of the specific period.

In addition, the center execution circuit 51 accesses the center storage circuit 52 to acquire the weather information IW and the precipitation amount information IP at the regular time intervals within a specific period for a specific area for prediction. That is, the center execution circuit 51 acquires information every 15 minutes such as weather information IW and precipitation amount information IP at 12:15, weather information IW and precipitation amount information IP at 12:30, and the like.

As illustrated in FIG. 4, the center execution circuit 51 acquires date information ID indicating the date corresponding to each point in time at 15-minute intervals within the specific period. Specifically, the center execution circuit 51 first associates the date corresponding to each point in time with the map illustrated in FIG. 4. This map indicates which week and day of the week each day of each month corresponds to. For example, a case will be discussed in which the 1st of X-th month is Wednesday. In this case, the center execution circuit 51 acquires 4 as the date information ID corresponding to the 1st of the X-th month. Then, the center execution circuit 51 acquires 5, 6, and 7 as date information IDs one by one every day after the X-th month 2nd. In the above example, the period from 12:00 to 15:00 does not cross the date. Therefore, in the above example, the center execution circuit 51 acquires the same date information ID for all the points in time.

The center execution circuit 51 acquires point-in-time information IT indicating a point in time corresponding to each point in time. The point-in-time information IT is obtained by converting a point in time such as 12:15 into a numerical value according to a predetermined rule.

The center execution circuit 51 acquires calendar information IC of the date corresponding to each point in time. The calendar information IC is, for example, a numerical value indicating information such as weekdays, holidays, and consecutive holidays.

In this manner, the center execution circuit 51 acquires six types of information for each of the twelve points in time at 15-minute intervals. In the present embodiment, the process of step S11 is a process of acquiring multiple input variables. As illustrated in FIG. 2, after step S11, the center execution circuit 51 advances the process to step S12.

As shown in FIG. 2, in step S12, the center execution circuit 51 generates various values acquired in the process of step S11 as input data X(1) to input data X(N) to the mapping M. Each piece of the input data includes input variables corresponding to six types of information about the corresponding point in time. N is an integer greater than 1. Also, N is a value that is incremented by one every time the regular interval of time elapses based on the oldest data. Therefore, in the above example, the input data X(1) is data at 12:15, and the input data X(N) is data at 15:00. As described above, six types of information are acquired for each of the twelve points in time. Therefore, in the present embodiment, N=12. Furthermore, N is the number of congestion variables to be described later.

As a specific example of the process of step S12, a case in which the target prediction point in time is 15:15 will be described. In this case, the center execution circuit 51 substitutes the average vehicle speed SPA, the weather information IW, the precipitation amount information IP, the date information ID, the point-in-time information IT, and the calendar information IC at 12:15 for input variables of the input data X(1). Similarly, the center execution circuit 51 substitutes information at each point in time for input variables of the input data X(2) to the input data X(N−1). Then, the average vehicle speed SPA, the weather information IW, the precipitation amount information IP, the date information ID, the point-in-time information IT, and the calendar information IC at 15:00 are substituted for input variables of the input data X(N).

Each of the average vehicle speeds SPA substituted in step S12 is an example of a congestion variable indicating the degree of congestion in the specific area at the regular time intervals within the specific period. Each of the average vehicle speeds SPA substituted in step S12 is an example of a variable indicating the speed of the vehicle 10. Each of the date information ID, the point-in-time information IT, and the calendar information IC substituted in step S12 is an example of a variable indicating the date and time in the specific area within the specific period. In addition, each of the weather information IW and the precipitation amount information IP substituted in step S12 is an example of a variable indicating the weather in the specific area within the specific period. After step S12, the center execution circuit 51 advances the process to step S13.

In step S13, the center execution circuit 51 outputs an output variable y(N+1) by inputting the input variables generated in the process of step S12 to the mapping M. The output variable y(N+1) indicates a predicted value of the average vehicle speed SPA after a lapse of the regular time interval from the end time of the specific period. As a specific example, when the end time of the specific period is 15:00, the output variable y(N+1) indicates a predicted value of the average vehicle speed SPA at 15:15. The average vehicle speed SPA output in step S13 is an example of a variable indicating the degree of congestion. Furthermore, the average vehicle speed SPA output in step S13 is an example of a variable indicating the speed of the vehicle 10.

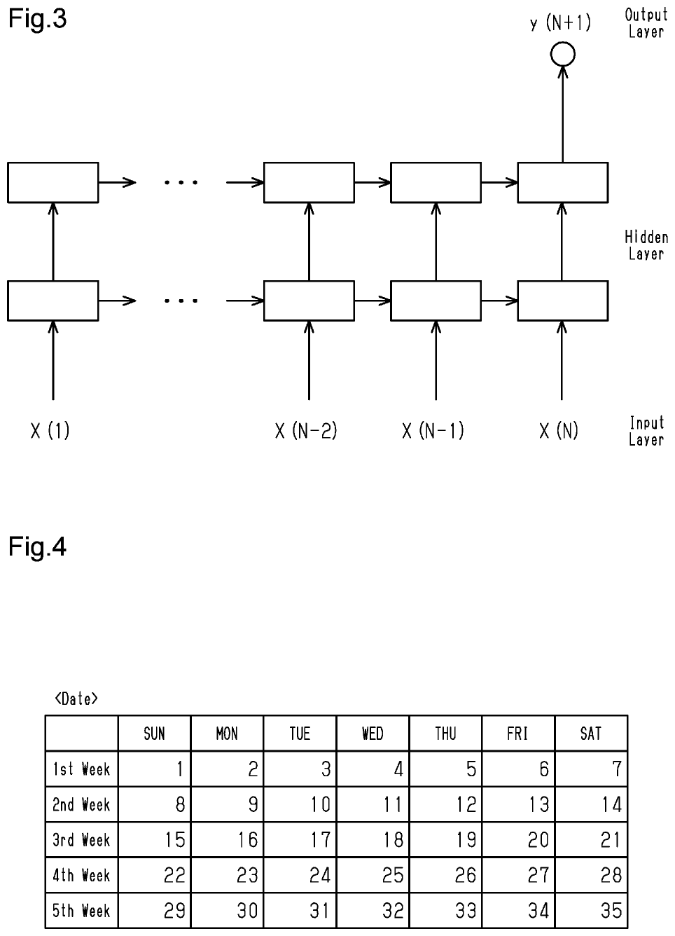

As illustrated in FIG. 3, an example of the mapping M is a LSTM neural network that can handle time-series data as a machine-learned model while holding information on transition along the time axis. Therefore, in the present embodiment, the mapping M includes a recurrent neural network that outputs an output variable when congestion variables within a specific period are input to the mapping M. This LSTM neural network is a type of recurrent neural network in which a mechanism called an LSTM block is provided in each hidden layer of the recurrent neural network so that propagation of time-series information can be adjusted. Specifically, as illustrated in FIG. 3, the mapping M has a configuration in which the output of the hidden layer connected to the input layer to which the input data X(N−1) at the previous point in time is input is reflected in the hidden layer connected to the input layer to which the input data X(N) is input. Similarly, the mapping M has a configuration in which the output of the hidden layer connected to the input layer to which the input data X(N−1) at the previous point in time is input is reflected on the hidden layer connected to the input layer to which the input data X(N−2) is input. The LSTM is referred to as a long short-term memory.

In the present embodiment, the mapping M is learned as follows, for example. First, the input data X(1) to the input data X(N) are acquired in the manner of steps S11 and S12 described above. In addition, the actual average vehicle speed SPA is acquired as the output variable y(N+1) corresponding to the input data X(1) to the input data X(N) in the manner of step S11 described above. Further, a set of training data obtained by combining the acquired data of the input data X(1) to the input data X(N) and the actual average vehicle speed SPA as a ground truth label is generated. Then, the mapping M is learned by machine learning based on multiple sets of training data.

The center storage circuit 52 of the data center 50 stores the predicted average vehicle speed SPA in association with the target prediction point in time and the target specific area. In the present embodiment, the processes of steps S12 and S13 are processes of outputting the output variable by inputting the acquired input variable to the mapping M. After step S13, the center execution circuit 51 ends the current prediction control.

After the first prediction control, the center execution circuit 51 can execute second and subsequent prediction controls for the same specific area. In step S11 of the second and subsequent prediction controls, the center execution circuit 51 accesses the center storage circuit 52 to acquire the average vehicle speed SPA calculated by the center execution circuit 51 in step S13 of the first prediction control as the average vehicle speed SPA within the specific period. At this time, when the average vehicle speed SPA calculated by the center execution circuit 51 in step S13 executed in the past does not exist as the average vehicle speed SPA within the specific period, the center execution circuit 51 acquires the average vehicle speed SPA predicted in step S13. For example, when the target prediction point in time in the second prediction control is 15:30, the average vehicle speed SPA predicted in step S13 in the first prediction control is acquired as the average vehicle speed SPA at 15:15.

In step S12 of the second prediction control, the center execution circuit 51 substitutes the average vehicle speed SPA, the weather information IW, the precipitation amount information IP, the date information ID, the point-in-time information IT, and the calendar information IC at 12:30 for input variables of the input data X(1). Similarly, the center execution circuit 51 substitutes the average vehicle speed SPA, the weather information IW, the precipitation amount information IP, the date information ID, the point-in-time information IT, and the calendar information IC at 15:15 for input variables of the input data X(N). As described above, the average vehicle speed SPA at 15:15 is the average vehicle speed SPA predicted in step S13 in the first prediction control. In addition, the weather information IW and the precipitation amount information IP at 15:15 are the weather information IW and the precipitation amount information IP predicted by the weather information center 70. After performing the second prediction control in this manner, the center execution circuit 51 can further execute the third and fourth prediction controls.

A specific period corresponding to the first output variable is defined as a first specific period, and a specific period corresponding to the second output variable is defined as a second specific period. In addition, the start time of the first specific period is defined as a first start time, and the end time of the first specific period is defined as a first end time. At this time, the start time of the second specific period is a second start time after a lapse of the regular time interval from the first start time. In the above example, the second start time is 12:15 that is 15 minutes after 12:00, which is the first start time. The end time of the second specific period is a second end time after a lapse of the regular time interval from the first end time. In the above example, the second end time is 15:15 after a lapse of 15 minutes from 15:00, which is the first end time.

In this case, the center execution circuit 51 acquires input variables including N average vehicle speeds SPA from the first start time to the first end time within the first specific period. The center execution circuit 51 inputs the acquired input variable to the mapping M to output the average vehicle speed SPA, which is the first output variable. Further, the center execution circuit 51 sets the average vehicle speed SPA of the second end time to the average vehicle speed SPA, which is the first output variable, and acquires input variables including N average vehicle speeds SPA from the second start time to the second end time within the second specific period. Then, the center execution circuit 51 inputs the acquired input variable to the mapping M to output the average vehicle speed SPA, which is the second output variable.

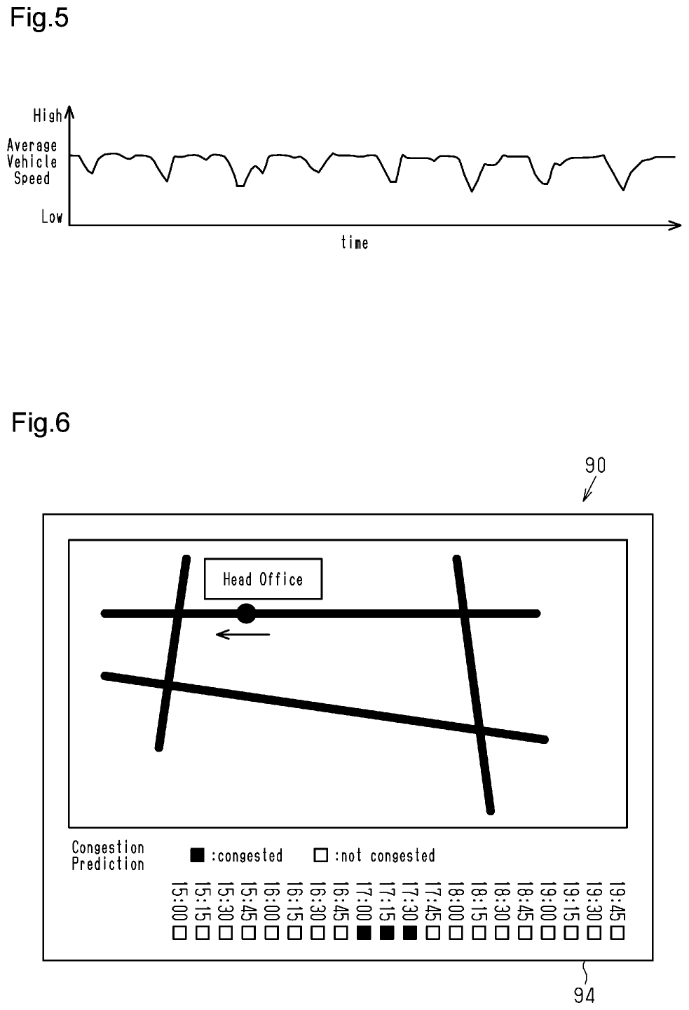

By using the average vehicle speed SPA output in the previous prediction control as the average vehicle speed SPA of the end time of the specific period in the subsequent prediction control, the center execution circuit 51 can repeatedly execute the third, fourth, . . . prediction controls. That is, when L is an arbitrary positive integer, the center execution circuit 51 can repeatedly execute the L-th prediction control and the (L+1)th prediction control consecutively. As the center execution circuit 51 repeatedly executes the prediction control in this manner, the transition of the predicted value of the average vehicle speed SPA as illustrated in FIG. 5 is obtained.

Distribution Control

Next, distribution control executed by the data center 50 and the personal terminal 90 will be described. The distribution control is executed between one data center 50 and each of the personal terminals 90. The personal terminal 90 executes distribution control every time the user performs an operation of requesting distribution via the display 94 of the personal terminal 90. The operation of requesting distribution includes an operation in which the user selects a specific area and a request period. As illustrated in FIG. 2, in the distribution control, the personal terminal 90 transmits a signal requesting distribution to the data center 50 together with a signal indicating the specific area and the request period selected by the user.

The center execution circuit 51 of the data center 50 transmits a signal indicating the average vehicle speed SPA predicted by the prediction control to the personal terminal 90. Specifically, the center execution circuit 51 selects surrounding specific areas located around the specific area based on the specific area selected by the user. Then, the center execution circuit 51 transmits, to the personal terminal 90, a signal indicating the average vehicle speed SPA corresponding to the request period selected by the user for the selected surrounding specific areas. As illustrated in FIG. 6, the center execution circuit 51 of the personal terminal 90 causes the display 94 to display a map indicating a specific area selected by the user and surroundings of the specific area. At this time, the center execution circuit 51 displays the specific area selected by the user with a black circle, for example. In addition, the center execution circuit 51 of the personal terminal 90 causes the display 94 to display information indicating congestion prediction for the request period selected by the user. At this time, the center execution circuit 51 displays, for example, a black square indicating that there is a traffic jam when the average vehicle speed SPA is less than a predetermined specified speed for each point in time included in the request period. An example of the specified speed is 10 km/h. Thereafter, the personal terminal 90 ends the current distribution control.

Operation of Present Embodiment

As the congestion in the specific area, the degree of congestion after a certain point in time tends to change due to the degree of congestion before the certain point in time. The center execution circuit 51 of the data center 50 outputs the output variable by inputting, to the mapping M, the input variable including the average vehicle speeds SPA at the regular time intervals in the specific period before the prediction point in time. That is, for the same area, the data center 50 predicts the average vehicle speed SPA after a lapse of the regular time interval from the end time of the specific period based on the average vehicle speed SPA at the regular time intervals within the specific period.

Advantages of Present Embodiment

(1) In the present embodiment, when predicting the degree of future congestion as described above, the degree of congestion within a specific period related to the same specific area is referred to. As a result, for example, the accuracy of prediction regarding the degree of congestion is improved as compared with a configuration in which the degree of congestion within a specific period is not referred to.

(2) When executing the second or subsequent prediction control for the same specific area, the center execution circuit 51 accesses the center storage circuit 52 to acquire the average vehicle speed SPA predicted in step S13 in the past prediction control as the average vehicle speed SPA within the specific period. Then, the center execution circuit 51 outputs the output variable by inputting, to the mapping M, the input variable including the average vehicle speed SPA predicted in step S13 in the past prediction control. That is, in the present embodiment, the output variable output in the past prediction control is used as the input variable in the subsequent prediction control. Therefore, every time the prediction control is repeated, a predicted value of the average vehicle speed SPA after a lapse of the regular time interval is obtained. As a result, it is possible to predict the degree of congestion for a long period by repeating the prediction multiple times.

(3) In the present embodiment, the variable indicating the degree of congestion, which is the output variable of the mapping M, is the average vehicle speed SPA, that is, the variable indicating the speed of the vehicle 10. This makes it easier to acquire the degree of congestion in more detail, for example, as compared with a case in which a variable indicating the presence or absence of congestion is output as an output variable.

(4) In the present embodiment, the mapping M includes a recurrent neural network that outputs an output variable by inputting multiple congestion variables within a specific period. As a result, the histories of the congestion variables included in the specific period are added to the output variable of the mapping M. As a result, the prediction accuracy is further improved.

(5) As the congestion in the specific area, the degree of congestion at a prediction point in time later than the specific period may change according to the date and time of the specific period. For example, the degree of congestion at the prediction point in time may change according to the day of the week of the specific period. Furthermore, for example, the degree of congestion at the prediction point in time may change according to the point in time of the specific period. Furthermore, for example, the degree of congestion at the prediction point in time may change depending on whether the date of the specific period is a weekday or a holiday.

In the present embodiment, the input variables of the mapping M include the date information ID, the point-in-time information IT, and the calendar information IC, which are variables indicating the date and time in the specific area within the specific period. As a result, for example, the prediction accuracy is improved as compared with a configuration in which the variable indicating the date and time in the specific area within the specific period is not considered.

(6) As the congestion in the specific area, the degree of congestion at a prediction point in time after the specific period may change according to the weather in the specific period. For example, the degree of congestion at the prediction point in time may change depending on whether the weather in a specific period is sunny, cloudy, rainy, or snowy. Furthermore, for example, the degree of congestion at the prediction point in time may change according to the precipitation amount in a specific period.

In the present embodiment, the input variable of the mapping M includes the weather information IW and the precipitation amount information IP, which are variables indicating the weather in the specific area within the specific period. As a result, for example, the prediction accuracy is improved as compared with a configuration in which a variable indicating the weather in the specific area within the specific period is not taken into consideration.

Modifications

The present embodiment can be modified as follows. The present embodiment and the following modifications can be implemented in combination with each other within a range not technically contradictory.

In the above embodiment, the input variable of the mapping M may be changed.

For example, as the congestion variable indicating the degree of congestion which is the input variable of the mapping M, other variables may be adopted instead of or in addition to the average vehicle speed SPA. As a specific example, the traffic volume in the specific area at the regular time intervals in the specific period may be adopted as the congestion variable, which is the input variable of the mapping M. The traffic volume is the number of vehicles 10 passing through the specific area within the regular time interval. Furthermore, as a specific example, the vehicle density in the specific area at the regular time intervals within the specific period may be adopted as the congestion variable which is the input variable of the mapping M. The vehicle density is an average value of the number of vehicles 10 located in a specific area within the regular time interval.

For example, the variable indicating the date and time in the specific area within the specific period as the input variable of the mapping M may be changed or omitted. As a specific example of the change, one or two types of information of the date information ID, the point-in-time information IT, and the calendar information IC may be adopted as variables indicating the date and time in the specific area within the specific period.

For example, the variable indicating the weather in the specific area within the specific period as the input variable of the mapping M may be changed or omitted. As a specific example of the change, one type of information of the weather information IW and the precipitation amount information IP may be adopted as a variable indicating the weather in the specific area within the specific period.

In the above embodiment, the configuration related to the specific period may be changed.

For example, the length of the specific period may be changed. As an example, the length of the specific period may be changed in a range of several tens of minutes to several days.

For example, the length of the regular time interval may be changed. As an example, the length of the regular time interval may be changed in a range of several minutes to several tens of minutes, or the like. As the length of the regular time interval decreases, it becomes easier to reflect the fluctuation of the congestion variable, but the fluctuation of the congestion variable may become excessively large. Therefore, it is preferable to determine an appropriate length of the regular time interval on the basis of experiments, simulations, or the like. When changing the length of the regular time interval or the length of the specific period, the number of congestion variables input to the mapping M may be changed.

In the above embodiment, the specific area may be changed.

Specifically, even on a road in the same traveling direction, when there are two or more lanes, the degree of congestion may be different for each lane. Therefore, the specific area may be, for example, an area divided every several tens of meters to several hundreds of meters along the traveling direction for a road in the same traveling direction and divided for each lane.

In the above embodiment, the output variable of the mapping M may be changed.

For example, as the variable indicating the degree of congestion, which is the output variable of the mapping M, other variables may be adopted instead of the average vehicle speed SPA. As a specific example, the traffic volume in the specific area may be adopted as the output variable of the mapping M. Furthermore, as a specific example, the vehicle density in the specific area may be adopted as the output variable of the mapping M.

In the above embodiment, the mapping M may be changed.

For example, a gated recurrent unit (GRU) neural network may be adopted as the mapping M instead of the LSTM neural network. Furthermore, for example, a general recurrent neural network in which the LSTM block is omitted may be adopted as the mapping M instead of the LSTM neural network. Furthermore, for example, the mapping M may include a forward propagation neural network instead of or in addition to the recurrent neural network.

The execution units and memories such as the center execution circuit 51 and the center storage circuit 52 are not limited to those including a CPU and a ROM and executing software processing. That is, the controller may be modified as long as it has any one of the following configurations (a) to (c).

(a) The controller includes one or more processors that execute various processes according to computer programs. The processor includes a CPU and a memory such as RAM and ROM. The memory stores program code or instructions configured to cause the CPU to execute processes. The memory, which is a non-transitory computer readable medium, includes any type of media that are accessible by general-purpose computers and dedicated computers.

(b) The controller includes one or more dedicated hardware circuits that execute various processes. The dedicated hardware circuits include, for example, an application specific integrated circuit (ASIC) and a field programmable gate array (FPGA).

(c) The controller includes a processor that executes part of various processes according to programs and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A congestion prediction device comprising:
an execution circuit; and
a memory, wherein
the memory stores mapping data that defines a mapping, and
the execution circuit is configured to
acquire input variables, and
output an output variable by inputting the acquired input variables to the mapping,
the mapping outputs the output variable when the input variables are input to the mapping,
the output variable indicates a degree of congestion in a predetermined specific area,
the mapping is learned in advance by machine learning,
the input variables include congestion variables,
each of the congestion variables indicates a degree of congestion in the specific area at regular time intervals within a specific period, and
the output variable is a variable indicating a degree of the congestion after a lapse of the regular time interval from an end time of the specific period.

2. The congestion prediction device according to claim 1, wherein
when N, which is a number of the congestion variable, is an integer greater than 1, L is any positive integer, and the output variable is output multiple times,
a first specific period is the specific period corresponding to an L-th output variable,
a second specific period is the specific period corresponding to the output variable of an (L+1)th output variable,
a first start time is a start time of the first specific period,
a first end time is an end time of the first specific period,
a second start time is a start time of the second specific period,
the second start time occurs one regular time interval after the first start time,
a second end time is an end time of the second specific period,
the second end time occurs one regular time interval after the first end time,
the execution circuit is configured to
acquire the input variables including the N congestion variables from the first start time to the first end time within the first specific period,
output the L-th output variable by inputting the acquired input variables to the mapping,
acquire the input variables including the N congestion variables from the second start time to the second end time within the second specific period while setting the congestion variable of the second end time to the L-th output variable, and
output the (L+1)th output variable by inputting the acquired input variables to the mapping.

3. The congestion prediction device according to claim 1, wherein
the congestion variable is a variable indicating a speed of a vehicle, and
the output variable is a variable indicating the speed of the vehicle.

4. The congestion prediction device according to claim 1, wherein
the mapping includes a recurrent neural network, and
the recurrent neural network outputs the output variable when the congestion variables within the specific period are input to the recurrent neural network.

5. The congestion prediction device according to claim 1, wherein
the input variables include a variable indicating a date and time in the specific area within the specific period as a variable different from the congestion variable.

6. The congestion prediction device according to claim 1, wherein
the input variables include a variable indicating weather in the specific area within the specific period as a variable different from the congestion variable.

7. A congestion prediction method executed by a congestion prediction device including an execution circuit and a memory, the congestion prediction method comprising:
storing, by the memory, mapping data that defines a mapping;
acquiring, by the execution circuit, input variables; and
outputting, by the execution circuit, an output variable by inputting the acquired input variables to the mapping, wherein
the mapping outputs the output variable when the input variables are input to the mapping,
the output variable indicates a degree of congestion in a predetermined specific area,
the mapping is learned in advance by machine learning,
the input variables include congestion variables,
each of the congestion variables indicates a degree of congestion in the specific area at regular time intervals within a specific period, and
the output variable is a variable indicating a degree of the congestion after a lapse of the regular time interval from an end time of the specific period.

8. A non-transitory computer readable medium storing a program for causing an execution circuit to execute a congestion prediction process, wherein
the congestion prediction process includes:
acquiring, by the execution circuit, input variables; and
outputting, by the execution circuit, an output variable by inputting the acquired input variables to a mapping, the mapping being defined by mapping data,
the mapping outputs the output variable when the input variables are input to the mapping,
the output variable indicates a degree of congestion in a predetermined specific area,
the mapping is learned in advance by machine learning,
the input variables include congestion variables,
each of the congestion variables indicates a degree of congestion in the specific area at regular time intervals within a specific period, and
the output variable is a variable indicating a degree of the congestion after a lapse of the regular time interval from an end time of the specific period.
